(19) United States
(12) Patent Application Publication
(10) Pub. No.: US 2026/0256317 A1
(43) Pub. Date: Sep. 3, 2026

(54) GRILL PAN ASSEMBLY

(71) Applicant: JUNSKY APPLIANCES LIMITED, Zhongshan (CN)

(72) Inventor: Huiqiang ZHU, Zhongshan (CN)

(21) Appl. No.: 19/651,828

(22) Filed: Apr. 20, 2026

(30) Foreign Application Priority Data
Mar. 2, 2026 (CN) 202620251106.7

(51) Int. Cl. A47J 37/07; A47J 36/32; A47J 37/06

(52) U.S. Cl. CPC A47J 37/0786; A47J 36/321; A47J 37/067

(57) ABSTRACT

A grill pan assembly, for placement above a charcoal or gas stove to grill food by heat conduction, including: a bracket and a grill pan detachably disposed on the bracket. The grill pan includes a first surface and a second surface that are oppositely disposed along a thickness direction, both the first surface and the second surface are configured to grill food. The first surface is provided with a plurality of protrusions protruding from the first surface in a direction away from the second surface. The grill pan assembly has a first state and a second state; And wherein, when the grill pan assembly is in the first state, the grill pan is placed on the bracket with the first surface facing upward; and when the grill pan assembly is in the second state, the grill pan is placed on the bracket with the second surface facing upward.

### CROSS REFERENCE TO RELATED APPLICATIONS

This application claims foreign priority of Chinese Patent Applications: No. 202620251106.7, filed on March 2, 2026 in the China National Intellectual Property Administration, the disclosures of all of which are hereby incorporated by reference.

### TECHNICAL FIELD

The present disclosure relates to the technical field of kitchen appliance equipment, in particular to a grill pan assembly.

### BACKGROUND

At present, with the advancement of society, people's living standards continue to improve, and an increasing number of people have developed a preference for home barbecuing or outdoor camping barbecuing. Owing to the rich diversity of food ingredients, a single grill pan may fail to satisfy the requirements of different groups of people.

### SUMMARY

In view of the foregoing circumstances, it is necessary to provide a grill pan assembly that is suitable for grilling different foods by adjusting the first and second surfaces of the grill pan.

To realize the above objective, the present disclosure provides a grill pan assembly, for placement above a charcoal or gas stove to grill food by heat conduction, including: a bracket and a grill pan, the grill pan being detachably disposed on the bracket; the grill pan comprises a first surface and a second surface that are oppositely disposed along a thickness direction, both the first surface and the second surface being configured to grill food; and Wherein the first surface is provided with a plurality of protrusions protruding from the first surface in a direction away from the second surface; the grill pan assembly has a first state and a second state; And wherein, when the grill pan assembly is in the first state, the grill pan is placed on the bracket with the first surface facing upward; and when the grill pan assembly is in the second state, the grill pan is placed on the bracket with the second surface facing upward.

In summary, in the grill pan assembly provided by the present disclosure, the grill pan is detachably arranged on the bracket. By adjusting the placement manner of the grill pan relative to the bracket, the first surface or the second surface of the grill pan can be made to face upward, the morphologies of the first surface and the second surface are different. The first surface is of an uneven configuration and is provided with a plurality of protrusions thereon, while the second surface is relatively flat. A user can select the corresponding surface to face upward for grilling food according to his or her own requirements, thereby eliminating the inconvenience of purchasing two different grill pans and being advantageous for saving costs.

### BRIEF DESCRIPTION OF THE DRAWINGS

FIG. 1 is a schematic structural diagram of a grill pan assembly according to one embodiment of the present disclosure, shown in a first state.

FIG. 2 is a schematic structural diagram of the grill pan assembly according to one embodiment of the present disclosure, shown in a second state.

FIG. 3 is a schematic structural diagram of a bracket of the grill pan assembly.

FIG. 4 is a cross-sectional view of the grill pan of the grill pan assembly, with the first surface facing upward.

FIG. 5 is a cross-sectional view of the grill pan of the grill pan assembly, with the second surface facing upward.

FIG. 6 is a first partial enlarged view of the grill pan of the grill pan assembly.

FIG. 7 is a second partial enlarged view of the grill pan of the grill pan assembly.

FIG. 8 is a front view of the grill pan assembly.

FIG. 9 is a schematic structural diagram of the grill pan assembly, which includes two grill pans.

FIG. 10 is an exploded view of the grill pan assembly of FIG. 9.

FIG. 11 is a schematic structural diagram of the grill pan assembly, which includes one grill pan.

FIG. 12 is a schematic structural diagram of the grill pan assembly, with a fixing frame connected to two grill pans.

FIG. 13 is a schematic structural diagram of the grill pan assembly, with a fixing frame connected to the same grill pan.

FIG. 14 is a schematic structural diagram of the fixing frame of the grill pan assembly.

FIG. 15 is a partial schematic structural diagram of the fixing frame mounted on the grill pan of the grill pan assembly.

FIG. 16 is an enlarged view of portion A in FIG. 15.

FIG. 17 is an exploded view of the fixing frame of the grill pan assembly.

FIG. 18 is an enlarged view of portion B in FIG. 17.

FIG. 19 is an enlarged view of portion C in FIG. 17.

FIG. 20 is an enlarged view of portion D in FIG. 17.

FIG. 21 is a partial cross-sectional view of the fixing frame of the grill pan assembly.

FIG. 22 is another partial cross-sectional view of the fixing frame of the grill pan assembly.

### Description of the reference numerals:

100, grill pan assembly; 10, bracket; 11, support platform; 12, through hole; 13, limiting portion; 20, grill pan; 211, first surface; 2111, protrusion; 2112, groove; 212, second surface; 221, first surrounding wall; 222, second surrounding wall; 231, first oil storage groove; 232, second oil storage groove; 241, first conduit; 242, second conduit; 25, limiting hole; 26, insertion hole; 27, snap-fit hole; 50, adjusting component; 60, fixing frame; 601, first end; 602, intermediate end; 603, second end; 604, temperature sensor; 605, signal transmission module; 606, mobile terminal; 608, mounting channel; 609, first snap-fit groove; 610, second snap-fit groove; 70, snap-fit component; 701, first snap-fit block; 702, first spring; 703, first pull cord; 704, second snap-fit block; 705, second spring; 706, second pull cord; 707, rotation shaft; 708, control component.

The following specific embodiments will further illustrate the present disclosure in conjunction with the above-mentioned drawings.

### DETAILED DESCRIPTION OF THE EMBODIMENTS

Hereinafter, the technical solutions in the embodiments of the present disclosure will be described with reference to the accompanying drawings in the embodiments of the present disclosure. It is apparent that the described embodiments are only part of the embodiments of the present disclosure, rather than all of the embodiments.

It should be noted that when one element is regarded as being “connected” to another element, it may be directly connected to the other element or an intermediately disposed element may exist simultaneously. When one element is regarded as being “disposed” on another element, it may be directly disposed on the other element or an intermediately disposed element may exist simultaneously. In the present disclosure, unless otherwise expressly specified and defined, the terms “installed,” “connected,” “linked,” “fixed,” and the like should be understood in a broad sense. For example, they may be a fixed connection, a detachable connection, or an integrally formed connection; they may be a direct connection or an indirect connection through an intermediate medium, and they may be internal communication between two elements. For a person of ordinary skill in the art, the specific meanings of the above terms in the present disclosure can be understood according to specific circumstances. The term “and/or” used herein includes any and all combinations of one or more of the associated listed items.

Unless otherwise defined, all technical and scientific terms used herein have the same meaning as commonly understood by a person skilled in the technical field to which the present disclosure belongs. The terms used in the description of the present disclosure herein are merely for the purpose of describing specific embodiments and are not intended to limit the present disclosure.

In the description of the embodiments of the present disclosure, the technical terms “first,” “second,” and the like are used only to distinguish different objects and cannot be construed as indicating or implying relative importance or implicitly indicating the number, specific order, or primary-secondary relationship of the indicated technical features. In the description of the embodiments of the present disclosure, the meaning of “plurality” is two or more, unless otherwise expressly and specifically limited.

The term “parallel” is used to describe an ideal state between two components. In an actual production or use state, a state approximately parallel may exist between the two components. For example, in conjunction with a numerical description, “parallel” may refer to an angle range between two straight lines being within 180°±10°, “parallel” may also refer to a dihedral angle range between two planes being within 180°±10°, and “parallel” may further refer to an angle range between a straight line and a plane being within 180°±10°. The two components described as being “parallel” need not be absolutely straight lines or planes; they may be substantially straight or planar, and from a macroscopic viewpoint, as long as the overall extension direction is a straight line or plane, the component can be regarded as a “straight line” or “plane.”

Reference to an “embodiment” herein means that a specific feature, structure, or characteristic described in connection with the embodiment may be included in at least one embodiment of the present disclosure. The appearance of the phrase in various places in the specification does not necessarily refer to the same embodiment, nor does it constitute an independent or alternative embodiment that is mutually exclusive with other embodiments. In the absence of conflict, the various embodiments of the present disclosure may be combined with one another.

The embodiments of the present disclosure will be further described below in conjunction with the accompanying drawings.

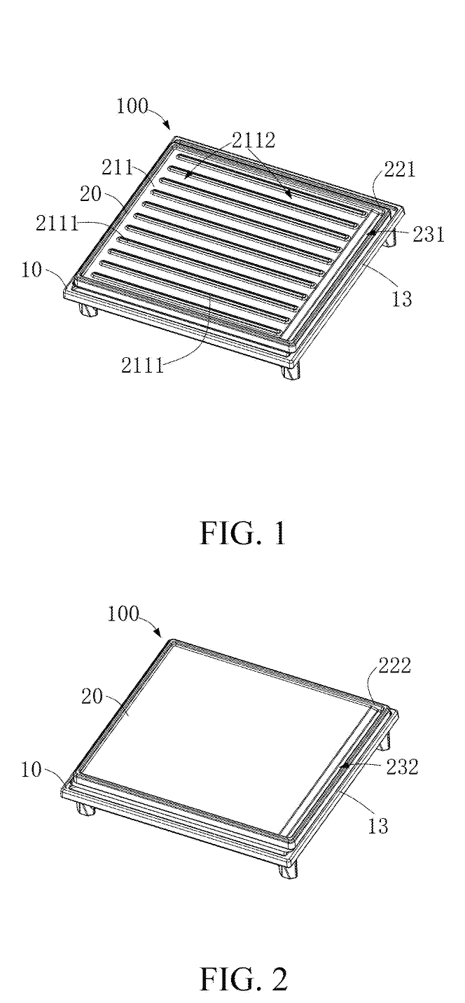

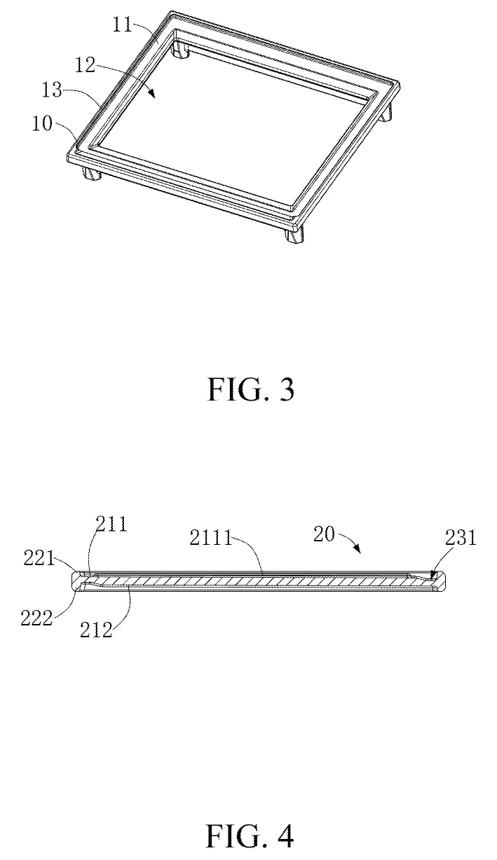

As shown in FIGS. 1 to 3, embodiments of the present disclosure provide a grill pan assembly 100 for being placed above a coal stove or a gas stove to grill food by means of heat conduction. In addition, the grill pan assembly 100 can also be heated by a portable gas stove such as a cassette stove or a split-type gas stove to grill food by means of heat conduction. The present disclosure does not impose any limitation on the specific application scenarios of the grill pan assembly 100.

The grill pan assembly 100 includes a bracket 10 and a grill pan 20. The grill pan 20 is detachably disposed on the bracket 10. The bracket 10 is configured to be placed on a countertop so as to support the grill pan 20 such that the grill pan 20 is positioned slightly higher than the countertop, thereby facilitating the placement/positioning of the grill pan 20.

The grill pan 20 includes a first surface 211 and a second surface 212 that are oppositely arranged along a thickness direction, both the first surface 211 and the second surface 212 can be used for grilling food. The first surface 211 and the second surface 212 have different morphologies. Specifically, the first surface 211 is provided with a plurality of protrusions 2111, and the plurality of protrusions 2111 protrudes from the first surface 211 in a direction away from the second surface 212. Compared with the first surface 211, the second surface 212 is smoother.

Further, the grill pan assembly 100 has a first state and a second state. When the grill pan assembly 100 is in the first state, the grill pan 20 is placed on the bracket 10 with the first surface 211 facing upward. When the grill pan assembly 100 is in the second state, the grill pan 20 is placed on the bracket 10 with the second surface 212 facing upward. The first state and the second state constitute two usage modes of the grill pan 20. In the first state, the first surface 211 provided with the plurality of protrusions 2111 faces upward; in the second state, the relatively smooth second surface 212 faces upward. A user can select, according to their own requirements, whether the first surface 211 or the second surface 212 faces upward. The same grill pan 20 provides diverse grilling manners, eliminating the trouble of purchasing two grill pans 20 and thereby contributing to a reduction in the user's usage cost.

It can be understood that, when the food is grilled using the first surface 211, the plurality of protrusions 2111 renders the first surface 211 uneven, which can prevent the food from completely adhering to the grill pan 20 and, during the grilling process, enable the food to form distinctive grill marks. For example, when meat products are grilled, grill marks corresponding to the plurality of protrusions 2111 are formed on the meat products.

In one embodiment, the grill pan 20 is made of any one of cast iron, aluminum alloy, stainless steel, carbon steel, copper, and copper alloy.

In one embodiment, the plurality of protrusions 2111 is strip-shaped and extend along the width direction or the length direction of the grill pan 20. The plurality of protrusions 2111 are spaced apart from one another, and multiple grooves 2112 are formed between every two adjacent protrusions 2111.

In one embodiment, the plurality of protrusions 2111 are dot-shaped, and the plurality of protrusions 2111 are arranged in a scattered-dot pattern or a honeycomb pattern.

In other words, the plurality of protrusions 2111 can reduce the contact area between ingredients and the pan surface, thereby decreasing adhesion and damage. The plurality of protrusions 2111 form local high-temperature contact lines or local high-temperature contact points, which more readily produce the charred aroma resulting from the Maillard reaction. At the same time, the generated grease is guided and collected by the multiple grooves 2112, thereby reducing free oil on the surface and lowering the probability of oil splashing.

In one embodiment, the grill pan 20 further includes a first surrounding wall 221 and a first oil storage groove 231 that are located on the same side as the first surface 211. The first surrounding wall 221 is arranged surrounding the first surface 211. The first oil storage groove 231 is disposed between the first surface 211 and the first surrounding wall 221 and is recessed in a direction toward the second surface 212. During use of the grill pan assembly 100, if excess oil is present on the first surface 211, the oil can flow and collect into the first oil storage groove 231, thereby reducing accumulation of oil on the first surface 211. In addition, the first surrounding wall 221 can perform a limiting function to prevent oil in the first surface 211 or the first oil storage groove 231 from overflowing.

In one embodiment, the multiple grooves 2112 formed between every two adjacent protrusions 2111 in the foregoing embodiment communicate with the first oil storage groove 231. When the grill pan assembly 100 is placed on a horizontal plane with the first surface 211 facing upward, liquid on the first surface 211 can flow along the multiple grooves 2112 toward the first oil storage groove 231.

In one embodiment, when viewed along the thickness direction of the grill pan 20, the first oil storage groove 231 is located on one side of the first surface 211, and the strip-shaped protrusions 2111 extend toward the first oil storage groove 231, thereby facilitating flow of oil within the multiple grooves 2112 toward the first oil storage groove 231. In one embodiment, when the grill pan assembly 100 is placed on a horizontal plane with the first surface 211 facing upward, the first surface 211 is inclined relative to the horizontal plane (as shown in FIG. 4), and a region of the first surface 211 proximate to the first oil storage groove 231 is lower than a region of the first surface 211 distal from the first oil storage groove 231, thereby facilitating flow of oil on the first surface 211 toward the first oil storage groove 231 and reducing accumulation of oil on the first surface 211.

In one embodiment, when viewed along the thickness direction of the grill pan 20, the first oil storage groove 231 is annular and is circumferentially disposed between the first surface 211 and the first surrounding wall 221, such that oil on the first surface 211 can flow toward the first oil storage groove 231 regardless of the flow direction, which is also beneficial for increasing the oil storage capacity of the first oil storage groove 231.

In one embodiment, the first surface 211 is an upward-arched arc shape in the middle. Specifically, the middle of the first surface 211 is higher while the edges are lower, thereby facilitating flow of oil on the first surface 211 toward the first oil storage groove 231 and reducing accumulation of oil on the first surface 211.

In one embodiment, the grill pan 20 further includes a second surrounding wall 222 and a second oil storage groove 232 that are located on the same side as the second surface 212. The second surrounding wall 222 is arranged around the second surface 212. The second oil storage groove 232 is disposed between the second surface 212 and the second surrounding wall 222 and is recessed in a direction toward the first surface 211. During use of the grill pan assembly 100, if excess oil is present on the second surface 212, the oil can flow into and be stored in the second oil storage groove 232, thereby reducing accumulation of oil on the second surface 212. In addition, the second surrounding wall 222 can perform a limiting function to prevent oil in the second surface 212 or the second oil storage groove 232 from overflowing.

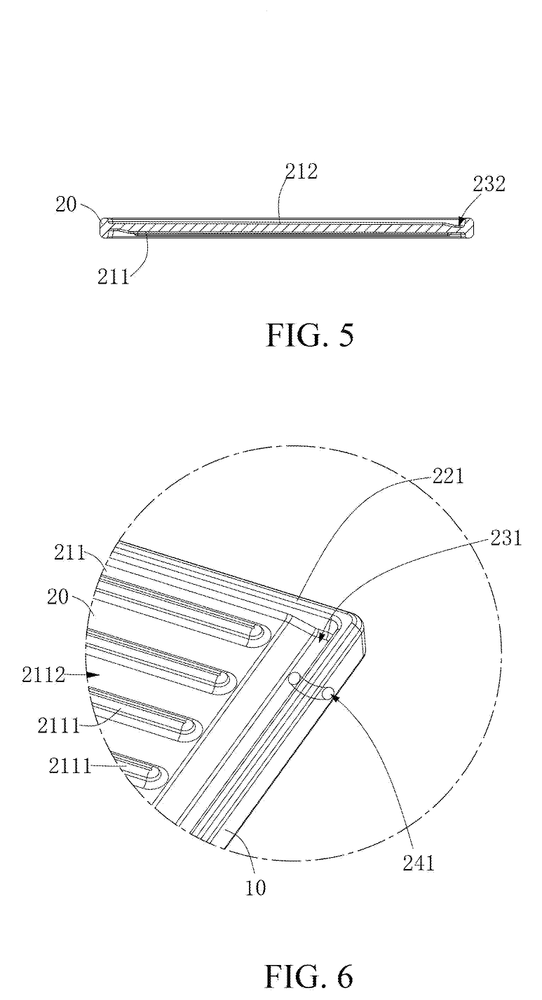

In one embodiment, when viewed along the thickness direction of the grill pan 20, the second oil storage groove 232 is located on one side of the second surface 212. In one embodiment, when the grill pan assembly 100 is placed on a horizontal plane with the second surface 212 facing upward (as shown in FIG. 5), the second surface 212 is inclined relative to the horizontal plane, and a region of the second surface 212 proximate to the second oil storage groove 232 is lower than a region of the second surface 212 distal from the second oil storage groove 232, thereby facilitating flow of oil on the second surface 212 toward the second oil storage groove 232 and reducing accumulation of oil on the second surface 212.

In one embodiment, when viewed along the thickness direction of the grill pan 20, the second oil storage groove 232 is annular and is circumferentially disposed between the second surface 212 and the second surrounding wall 222, such that oil on the second surface 212 can flow toward the second oil storage groove 232 regardless of the flow direction, which is also beneficial for increasing the oil storage capacity of the second oil storage groove 232.

In one embodiment, the second surface 212 is an arc shape that is arched upward in the middle. Specifically, the middle of the second surface 212 is higher while the edges are lower, thereby facilitating flow of oil on the second surface 212 toward the second oil storage groove 232 and reducing accumulation of oil on the second surface 212.

As shown in FIG. 6, in one embodiment, the grill pan 20 further includes a first conduit 241, one end of the first conduit 241 is disposed at a bottom of the first oil storage groove 231 and the other end is disposed on a side wall of the grill pan 20 or on one side of the second surface 212. The first conduit 241 is configured to drain liquid from inside the first oil storage groove 231 to the exterior. By providing the first conduit 241, the oil inside the first oil storage groove 231 can be drained without the need to disassemble the grill pan 20 or flip the grill pan 20. Moreover, the oil inside the first oil storage groove 231 can be drained without interrupting the food grilling process, thereby improving convenience.

In one embodiment, the grill pan assembly 100 further includes a first drainage tube (not shown in the figures), the first drainage tube is connected to the other end of the first conduit 241 and is configured to guide the liquid flowing out of the first conduit 241 to the exterior, which is beneficial for avoiding dripping that would otherwise contaminate the surrounding environment.

In one embodiment, the grill pan assembly 100 further includes a first plug (not shown in the figures), the first plug can be inserted into the other end of the first conduit 241 so as to block the first conduit 241. It can be understood that the first plug and the first drainage tube can be used as accessories. The first plug is employed when there is no need to drain liquid from the first oil storage groove 231, and the first drainage tube is employed when there is a need to drain liquid from the first oil storage groove 231.

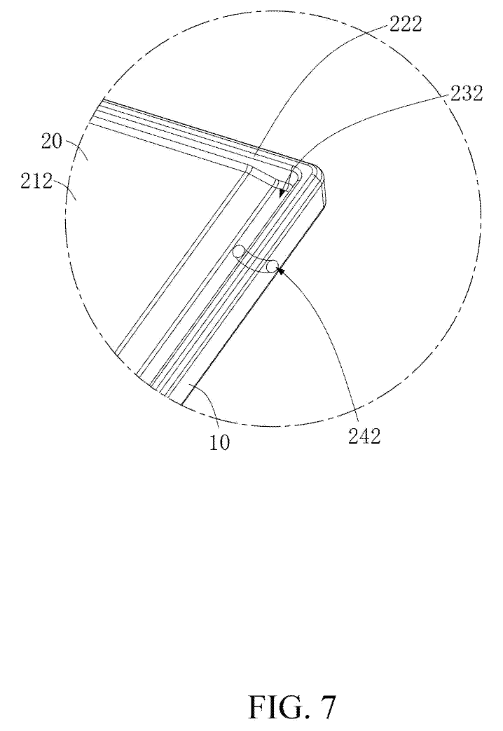

As shown in FIG. 7, in one embodiment, the grill pan 20 further includes a second conduit 242, one end of the second conduit 242 is disposed at the bottom of the second oil storage groove 232 and the other end is disposed on a side wall of the grill pan 20 or on one side of the first surface 211. The second conduit 242 is configured to drain liquid from inside the second oil storage groove 232 to the exterior. By providing the second conduit 242, the oil inside the second oil storage groove 232 can be drained without the need to disassemble the grill pan 20 or flip the grill pan 20. Moreover, the oil inside the second oil storage groove 232 can be drained without interrupting the food grilling process, thereby improving convenience.

In one embodiment, the grill pan assembly 100 further includes a second drainage tube (not shown in the figures), the second drainage tube is connected to the other end of the second conduit 242 and is configured to guide the liquid flowing out of the second conduit 242 to the exterior, which is beneficial for avoiding dripping that would otherwise contaminate the surrounding environment.

In one embodiment, the grill pan assembly 100 further includes a second plug (not shown in the figures), the second plug is configured to be inserted into and plug the other end of the second conduit 242 so as to seal and block the second conduit 242. It can be understood that the second plug and the second drainage tube may be used as accessories, the second plug being employed when there is no need to drain liquid from the second oil storage groove 232, and the second drainage tube being employed when it is necessary to drain the liquid from the second oil storage groove 232.

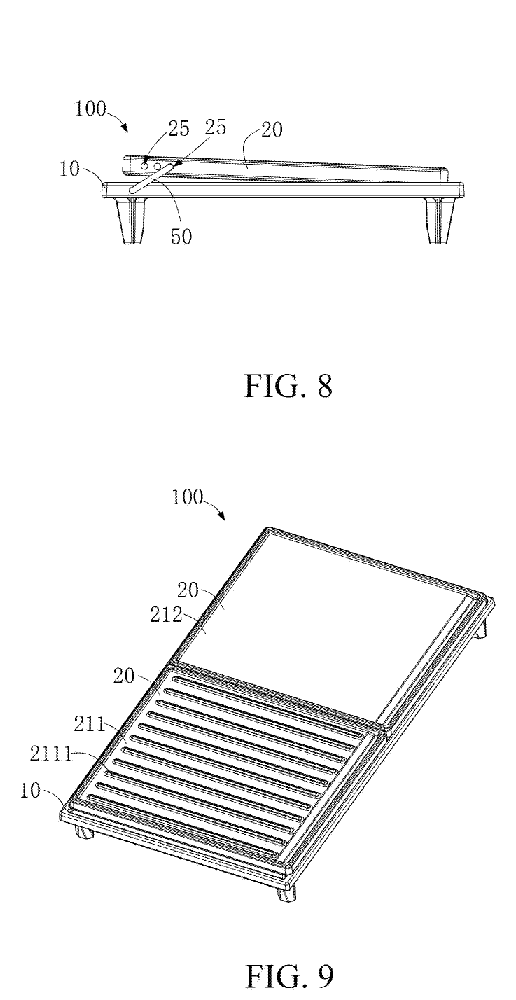

As shown in FIG. 8, in one embodiment, the grill pan assembly 100 further includes an adjusting component 50, one end of the adjusting component 50 is rotatably connected to the bracket 10 and the other end is movably supported on the grill pan 20. By rotating the adjusting component 50, the position at which the adjusting component 50 connects to the grill pan 20 is changed, which can be used to adjust the angle at which the grill pan 20 is placed on the bracket 10. For example, when grilling meat products, if it is desired that the grease precipitated from the meat products flow rapidly toward the oil storage groove, the grill pan 20 can be arranged in an inclined manner by means of the adjusting component 50, thereby facilitating rapid flow of the grease on the first surface 211 or the second surface 212 toward the corresponding oil storage groove.

In one embodiment, the grill pan 20 is provided with a plurality of limiting holes 25, the plurality of limiting holes 25 are configured for insertion of the adjusting component 50. By rotating the adjusting component 50 so that it is inserted into different limiting holes 25, the angle of the grill pan 20 relative to the bracket 10 can be adjusted.

Through cooperative use of the adjusting component 50 and the limiting holes 25, the relative position of the grill pan 20 with respect to the flame can be changed. In other words, because the heights in contact with the flame are different, different regions of the grill pan 20 (it can be understood that the higher regions are weak-fire regions and the lower regions are strong-fire regions) exhibit different temperature variations. For food ingredients with non-uniform thickness, for example, beef that is thicker on one half and thinner on the other half, the angle at which the grill pan 20 is placed on the bracket 10 can be adjusted so as to uniformly grill the beef, thereby reducing the probability of “burning at thin portions and undercooking at thick portions.” At the same time, during the grilling process, the thicker portions of the ingredients will produce more grease, which can be conducted away at an improved rate.

As shown in FIGS. 1 to 3, in one embodiment, the bracket 10 includes a support platform 11 and a through hole 12 penetrating the support platform 11 from top to bottom, the grill pan 20 is placed on the support platform 11, and the through hole 12 is located below the grill pan 20. In use, the region of the grill pan 20 located within the range of the through hole 12 is positioned above the flame for direct heating.

In one embodiment, the bracket 10 further includes a limiting portion 13 disposed above the support platform 11. When the grill pan 20 is placed on the support platform 11, the limiting portion 13 is configured to abut against the peripheral side wall of the grill pan 20, thereby restricting lateral movement of the grill pan 20, which is beneficial to improving the stability of the connection between the grill pan 20 and the bracket 10. In one embodiment, the limiting portion 13 is arranged in an annular shape and is shaped to mate with the outer contour of the grill pan 20. In one embodiment, the bracket 10 includes a plurality of limiting portions 13, and the plurality of limiting portions 13 is spaced apart along the outer contour shape of the grill pan 20, which helps improve the stability of the connection between the grill pan 20 and the bracket 10.

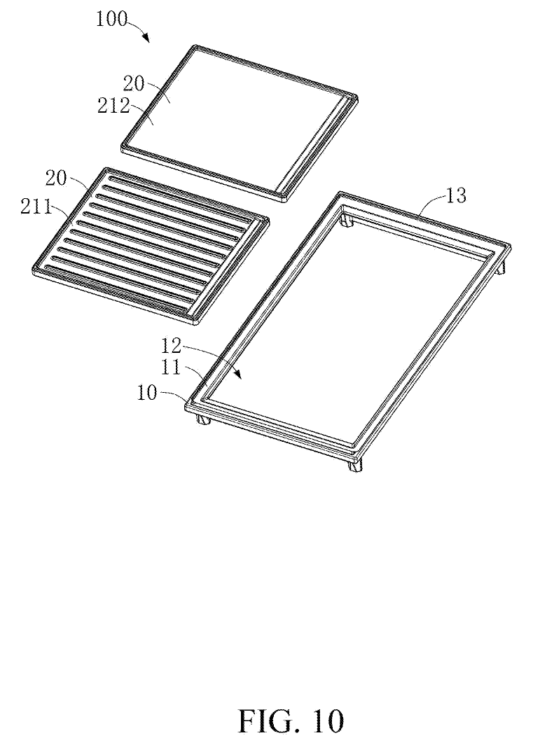

As shown in FIGS. 9 and 10, in one embodiment, the grill pan assembly 100 includes two grill pans 20, and the two grill pans 20 are arranged side by side in the transverse direction on the support platform 11. When the grill pan assembly 100 is placed on a horizontal surface, the first surfaces 211 of both grill pans 20 face upward, or the second surfaces 212 of both grill pans 20 face upward, or the first surface 211 of one of the two grill pans 20 faces upward while the second surface 212 of the other faces upward. In this embodiment, the bracket 10 can simultaneously accommodate two grill pans 20 placed side by side, and the two grill pans 20 may have the same face upward or different faces upward; the user can arbitrarily select according to his or her own barbecue requirements, which is beneficial to improving the diversity and convenience of using the grill pan assembly 100 to grill actual food items.

In one embodiment, the size of the bracket 10 is adapted to two grill pans 20, but the grill pan assembly 100 may also include only one grill pan 20, and the grill pan 20 may be placed at one placement position on the bracket 10 or at another placement position.

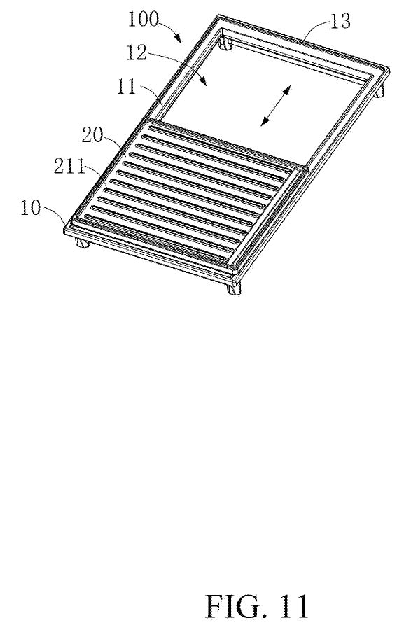

Further, as shown in FIG. 11, the grill pan 20 can also be movably placed on the support platform 11 and is capable of sliding to adjust its position along the length direction of the bracket 10. With such an arrangement, the user can slide the grill pan 20 to adjust the position at which the grill pan 20 is placed on the bracket 10, thereby adaptively adjusting the relative position between the grill pan 20 and the flame below.

In one embodiment, one of the bracket 10 and the grill pan 20 is provided with a guide post and the other is provided with a guide groove. The guide post is inserted into the guide groove, and the extending direction of the guide groove is parallel to the sliding direction of the grill pan 20 relative to the bracket 10. By providing the guide post and the guide groove in mutual cooperation, the stability of sliding of the grill pan 20 relative to the bracket 10 is improved.

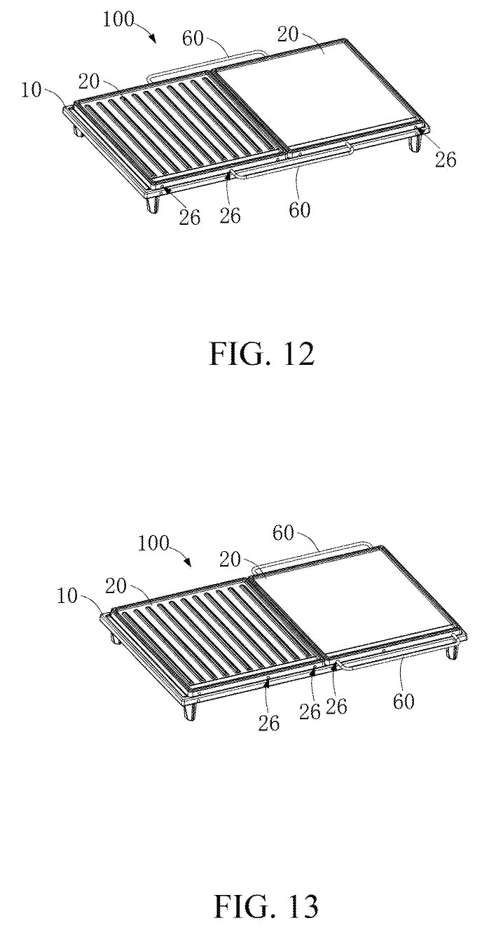

As shown in FIGS. 12 and 13, in one embodiment, the grill pan assembly 100 further includes a fixing frame 60 connected to the grill pan 20. By providing the fixing frame 60, lifting of the grill pan 20 or hanging of the grill pan 20 is facilitated.

In one embodiment, the fixing frame 60 is fixedly connected to the grill pan 20.

In one embodiment, the grill pan 20 includes at least two insertion holes 26, and two ends of the fixing frame 60 are detachably inserted into two insertion holes 26. In this embodiment, the fixing frame 60 is designed to be detachable, so that the user can choose whether to install the fixing frame 60 according to his or her own requirements, which is beneficial to satisfying the needs of different customers. In one embodiment, the at least two insertion holes 26 are provided on a side wall of the grill pan 20.

In one embodiment, when the grill pan assembly 100 includes two grill pans 20, the fixing frame 60 has a third state and a fourth state relative to the two grill pans 20.

When the fixing frame 60 is in the third state, both ends of the fixing frame 60 are inserted into two insertion holes 26 of the same grill pan 20. At this time, the primary function of the fixing frame 60 is to facilitate lifting of the grill pan 20.

When the fixing frame 60 is in the fourth state, one end of the fixing frame 60 is inserted into one insertion hole 26 of one grill pan 20, the other end is inserted into one insertion hole 26 of the other grill pan 20, and the connecting line connecting the two ends of the fixing frame 60 is parallel to the arrangement direction of the two grill pans 20. At this time, the primary function of the fixing frame 60 is to limit and connect the two grill pans 20, thereby reducing the risk of mutual movement or shaking between the two grill pans 20.

In one embodiment, the fixing frame 60 is C-shaped. In certain application scenarios, the fixing frame 60 can be used to place meat tongs, rags or the like, thereby facilitating convenient use and placement by the user.

It should be understood that the material of the fixing frame 60 may be manufactured from a high-temperature-resistant material, such as silicone rubber or the like.

In summary, in the grill pan assembly 100 provided by the present disclosure, the grill pan 20 is detachably arranged on the bracket 10. By adjusting the placement manner of the grill pan 20 relative to the bracket 10, the first surface 211 or the second surface 212 of the grill pan 20 can be made to face upward. The first surface 211 and the second surface 212 have different morphologies: the first surface 211 is of a concave-convex uneven shape and is provided with a plurality of protrusions 2111 and grooves 2112, while the second surface 212 is relatively flat. The user can select the corresponding face to face upward for grilling food according to his or her own needs, thereby eliminating the trouble of purchasing two different grill pans 20 and being beneficial to cost savings.

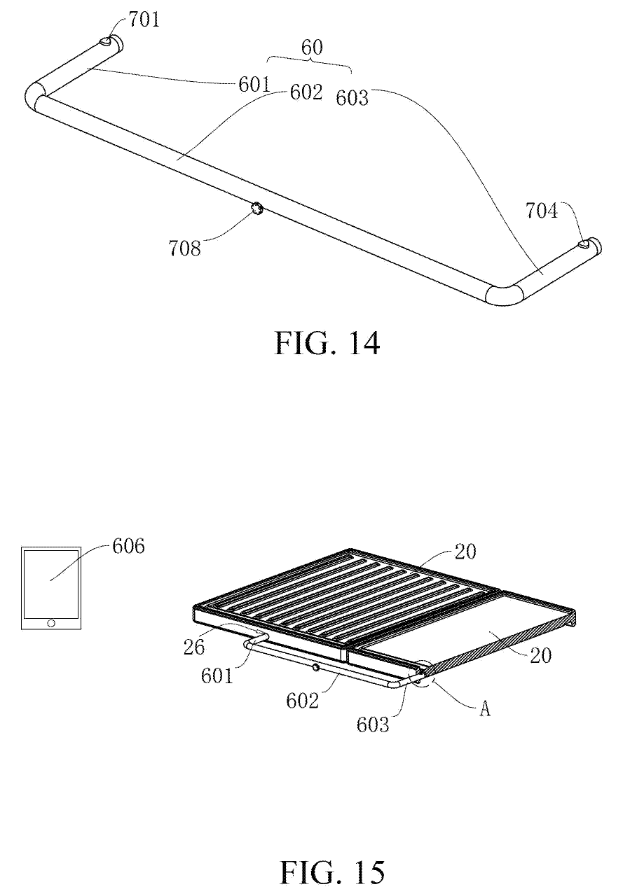

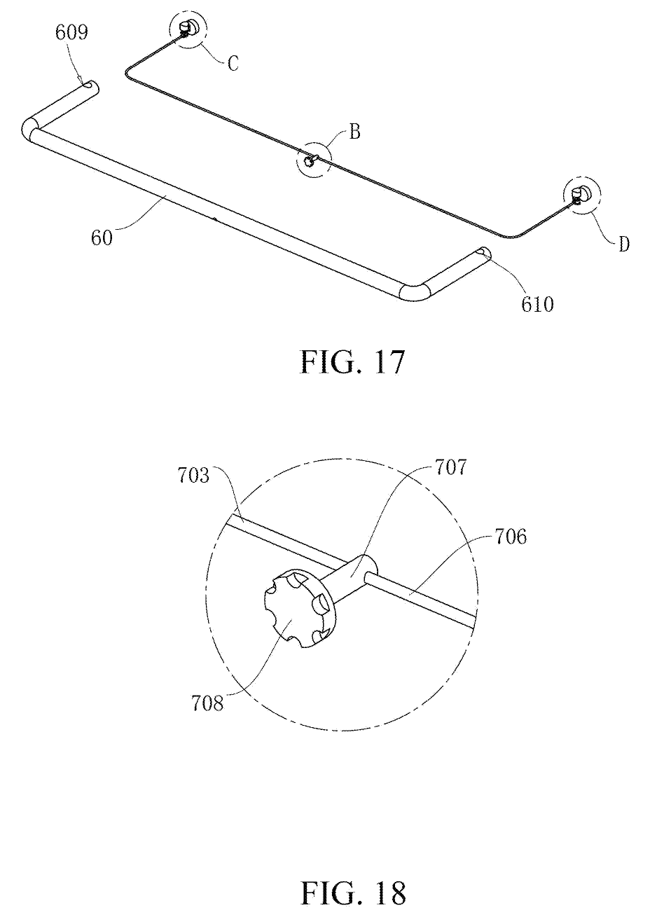

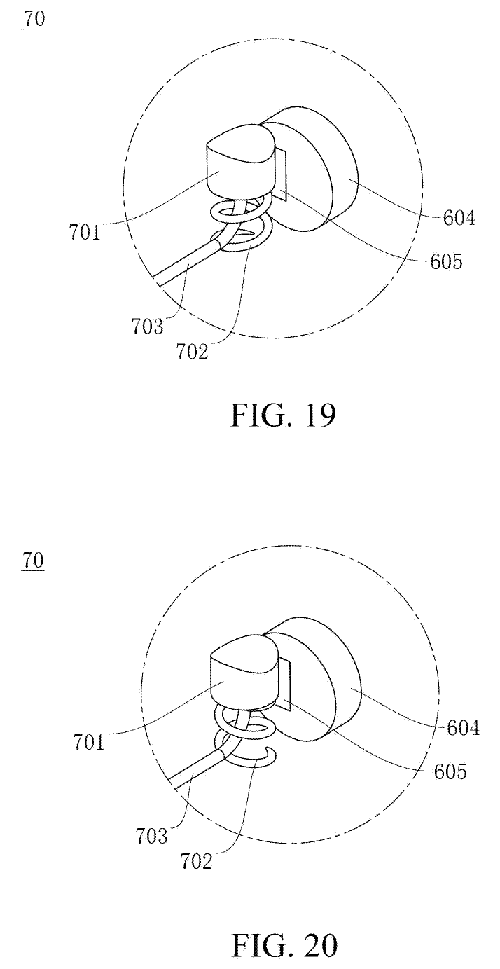

With reference to FIGS. 14 to 21, in one embodiment, the fixing frame 60 includes a first end 601, an intermediate end 602 and a second end 603 that are fixedly connected in sequence. The first end 601 and the second end 603 respectively form a 90° included angle with the intermediate end 602, and the distal ends of the first end 601 and the second end 603 are each provided with a temperature sensor 604, the temperature sensor 604 being inserted into the insertion hole 26. The fixing frame 60 further includes a signal transmission module 605 electrically connected to temperature sensors 604 on the distal ends of the first end 601 and the second end 603. The signal transmission module 605 is configured to wirelessly send the temperature signal detected by the temperature sensor 604 to a mobile terminal 606.

In this embodiment, the fixing frame 60 is detachably connected to the grill pan 20. After the two ends of the fixing frame 60 are respectively inserted into two corresponding insertion holes 26, the temperature sensors 604 arranged at the distal ends can extend into positions close to the grill pan 20 so as to detect the temperature at the corresponding positions. Through the signal transmission module 605 provided on the fixing frame 60, the temperature signal detected by the temperature sensor 604 can be sent to the mobile terminal 606 in real time, allowing the user to view the current temperature information via the mobile terminal 606, thereby facilitating mastery of the heating state of the grill pan 20.

Referring to FIG. 15, further, the mobile terminal 606 may be a mobile phone, a tablet computer, or any other electronic device having data receiving and display functions. A user may view the detection result of the corresponding temperature sensor 604 through an application program on the mobile terminal 606. The detection result may be a real-time temperature value or a temperature variation condition. Through the above arrangement, the necessity for the user to directly contact the grill pan 20 or to approach a high-temperature region to observe the temperature can be reduced, thereby improving the convenience of use.

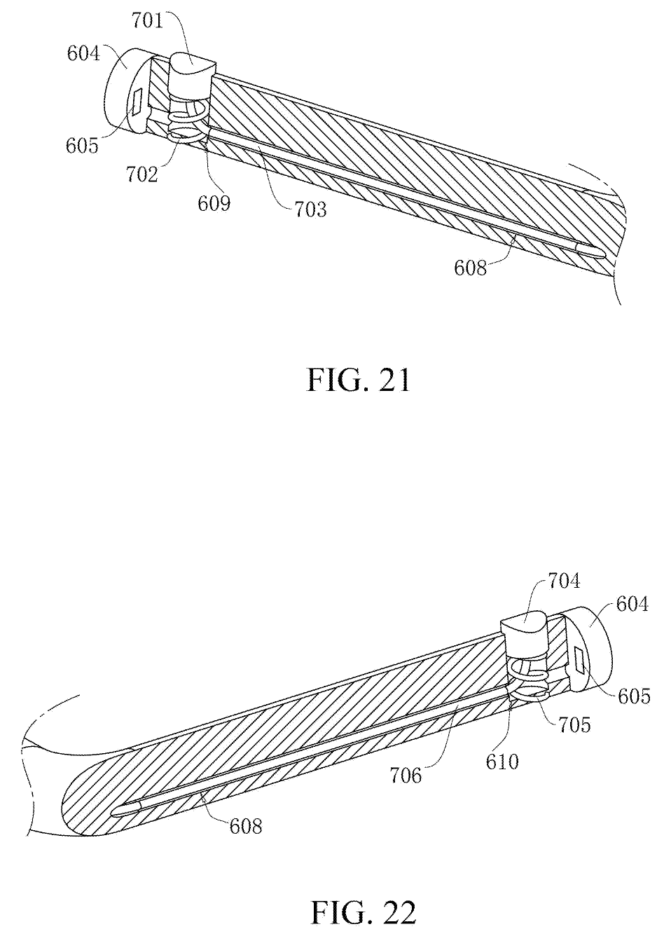

Referring to FIG. 21 and FIG. 22, in some embodiments, when the fixing frame 60 is connected to two grill pans 20, the temperature sensor 604 located on the first end 601 is configured to detect the temperature of one of the grill pans 20, and the temperature sensor 604 located on the second end 603 is configured to detect the temperature of the other grill pan 20. In this manner, the user can simultaneously acquire temperature information of the two grill pans 20 so as to perform separate control according to the baking requirements of different food ingredients.

In this embodiment, the signal transmission module 605 is a Bluetooth module so as to establish a wireless connection with the mobile terminal 606. The Bluetooth communication mode provides convenient connection and low power consumption, and is therefore suitable for temperature data transmission in the usage scenario of the grill pan assembly 100. Of course, in other embodiments, the signal transmission module 605 may also adopt other wireless communication modes, and the present disclosure does not impose any limitation thereon.

In one embodiment, the first end 601 and the second end 603 are made of a heat-conducting material, while the intermediate end 602 is made of a heat-insulating material.

The first end 601 and the second end 603 may be fixedly arranged together with the temperature sensor 604 such that heat from the grill pan 20 can be transferred to the temperature sensor 604 more rapidly, thereby shortening the response time of temperature detection. The intermediate end 602 can serve as a portion for the user to hold or operate. By providing a heat-insulating material, the influence of high temperature on the operating portion can be reduced.

In some embodiments, after the first end 601 and the second end 603 of the fixing frame 60 are inserted into the insertion holes 26 of the grill pan 20, the first end 601 and the second end 603 are arranged in contact with or close to the corresponding portions of the grill pan 20 so as to sense the temperature at the corresponding positions of the grill pan 20. The temperature sensor 604 is arranged inside the first end 601 and/or the second end 603 or at a position close to the end thereof, and the first end 601 and the second end 603 are used to transfer heat at the corresponding positions of the grill pan 20 to the temperature sensor 604, thereby realizing detection of the temperature of the grill pan 20.

In some embodiments, a housing is provided on the outer side of the temperature sensor 604, and the housing is configured to protect the temperature sensor 604 so as to reduce the influence of the high-temperature environment, oil stains, carbon deposits, and external collisions on the temperature sensor 604. Thereby improving the use stability and service life of the temperature sensor 604 in a barbecue environment. The housing may be made of a high-temperature-resistant material. The material, thickness, and structure of the housing may be set according to the temperature-measurement requirements so as to achieve a balance between protective performance and temperature-measurement response performance.

In some embodiments, the first end 601 and the second end 603 are made of a heat-conducting material so as to transfer heat at the corresponding positions of the grill pan 20 to the temperature sensor 604, thereby improving the response speed of temperature detection. The intermediate end 602 is made of a heat-insulating material so as to reduce the transfer of heat from the first end 601 and the second end 603 toward the intermediate end 602, thereby improving the operational safety and comfort of the fixing frame 60 during use.

In some embodiments, the temperature detection result may be corrected or calibrated according to the material characteristics of the first end 601 and the second end 603, the structure of the housing of the temperature sensor 604, and the mounting position of the temperature sensor 604, so as to improve the reference value of the temperature information.

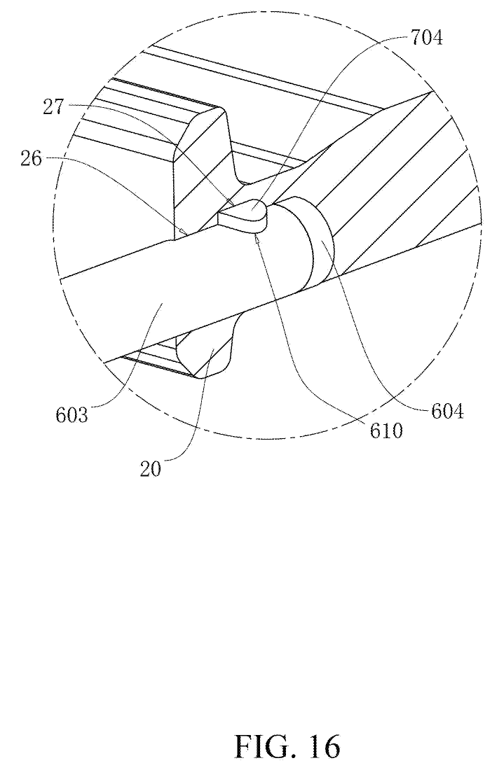

Referring to FIG. 15 and FIG. 16, in one embodiment, two snap-fit holes 27 are provided on the inner sides of the at least two insertion holes 26, and the fixing frame 60 is provided with two snap-fit components 70 capable of cooperating with the two snap-fit holes 27. When the two snap-fit components 70 are in a clamped state, the two snap-fit components 70 are embedded into the two snap-fit holes 27 so as to relatively fix the fixing frame 60 to the grill pan 20. When the two snap-fit components 70 are in a released state, the two snap-fit components 70 are disengaged from the two snap-fit holes 27 so that the fixing frame 60 can be pulled out relative to the grill pan 20.

In this embodiment, after the fixing frame 60 is inserted into the two insertion holes 26, the two snap-fit components 70 can cooperate with the two snap-fit holes 27 to limit and fix the fixing frame 60. Thereby preventing the fixing frame 60 from loosening, falling off, or undergoing positional deviation during use. Through the above arrangement, the fixing frame 60 can maintain relative stability after being connected to the grill pan 20, which is beneficial for keeping the temperature sensor 604 at the predetermined detection position and thereby improving the stability of the temperature-measurement process.

Referring to FIGS. 16 to 22, in one embodiment, a mounting channel 608 is provided inside the fixing frame 60, a first snap-fit groove 609 is provided at the first end 601, a second snap-fit groove 610 is provided at the second end 603, and each snap-fit component 70 includes: a first snap-fit block 701, a first spring 702, a first pull cord 703, a second snap-fit block 704, a second spring 705, a second pull cord 706, and a rotating shaft 707.

The first snap-fit block 701 is slidably connected to the first snap-fit groove 609. The first spring 702 is located between the first snap-fit block 701 and the groove bottom of the first snap-fit groove 609 and is configured to drive the first snap-fit block 701 to embed into the corresponding snap-fit hole 27. One end of the first pull cord 703 is fixedly connected to the first snap-fit block 701 and the other end is located in the mounting channel 608. The second snap-fit block 704 is slidably connected to the second snap-fit groove 610. The second spring 705 is located between the second snap-fit block 704 and the groove bottom of the second snap-fit groove 610 and is configured to drive the second snap-fit block 704 to embed into the corresponding snap-fit hole 27. One end of the second pull cord 706 is fixedly connected to the second snap-fit block 704 and the other end is located in the mounting channel 608. One end of the rotating shaft 707 is located inside the mounting channel 608 and the other end passes through the intermediate end 602, and the other ends of the first pull cord 703 and the second pull cord 706 are both wound around one end of the rotating shaft 707.

When the rotating shaft 707 is rotated, the first pull cord 703 drives the first snap-fit block 701 to move in a direction away from the corresponding snap-fit hole 27 so that the first snap-fit block 701 disengages from the corresponding snap-fit hole 27. The second pull cord 706 drives the second snap-fit block 704 to move in a direction away from the corresponding snap-fit hole 27 so that the second snap-fit block 704 disengages from the corresponding snap-fit hole 27. After both the first snap-fit block 701 and the second snap-fit block 704 have disengaged from their corresponding snap-fit holes 27, the fixing frame 60 can be pulled out from the corresponding insertion holes 26. When the external force acting on the rotating shaft 707 is removed, the first spring 702 drives the first snap-fit block 701 to move toward the corresponding snap-fit hole 27 and to embed into the corresponding snap-fit hole 27; the second spring 705 drives the second snap-fit block 704 to move toward the corresponding snap-fit hole 27 and to embed into the corresponding snap-fit hole 27.

In this embodiment, the first snap-fit block 701 and the second snap-fit block 704 are respectively arranged at the two ends of the fixing frame 60 and are capable of sliding within the corresponding snap-fit grooves. The first spring 702 and the second spring 705 respectively apply outward elastic forces to the first snap-fit block 701 and the second snap-fit block 704 so that the first snap-fit block 701 and the second snap-fit block 704 have a tendency to protrude outward. When the two ends of the fixing frame 60 are inserted into the insertion holes 26, the first snap-fit block 701 and the second snap-fit block 704 can temporarily retract under the insertion force. After the fixing frame 60 has been inserted to the predetermined position, the first snap-fit block 701 and the second snap-fit block 704 pop out under the action of the corresponding springs and respectively embed into the corresponding snap-fit holes 27, thereby realizing the clamped fixation between the fixing frame 60 and the grill pan 20.

The mounting channel 608 is arranged inside the fixing frame 60, and both the first pull cord 703 and the second pull cord 706 extend into the mounting channel 608 and are connected to the rotating shaft 707. By rotating the rotating shaft 707, the first pull cord 703 and the second pull cord 706 can be driven simultaneously, thereby respectively pulling the first snap-fit block 701 and the second snap-fit block 704 to move in the direction away from the corresponding snap-fit holes 27 so that the first snap-fit block 701 and the second snap-fit block 704 exit the corresponding snap-fit holes 27. At this time, the clamped relationship between the fixing frame 60 and the grill pan 20 is released, and the fixing frame 60 can be pulled out from the corresponding insertion holes 26.

When the user ceases to apply external force to the rotating shaft 707, the rotating shaft 707 no longer continues to drive the first pull cord 703 and the second pull cord 706 to pull the corresponding snap-fit blocks, and the first snap-fit block 701 and the second snap-fit block 704 move outward again under the elastic force of the corresponding springs and return to the position where they can cooperate with the snap-fit holes 27. Through the above arrangement, the fixing frame 60 can automatically clamp and fix itself after installation and can achieve rapid unlocking by rotating the rotating shaft 707 when disassembly is required, thereby balancing connection stability with the convenience of assembly and disassembly.

Referring to FIG. 18, further, the end of the rotating shaft 707 that passes through the intermediate end 602 is provided with a control component 708, which is convenient for operation, for example, a knob, a toggle member, or any other component that allows the user to apply force. The user can rotate the component to drive the rotating shaft 707 to rotate, thereby controlling the retraction action of the first snap-fit block 701 and the second snap-fit block 704. This operation mode has a relatively simple structure and is convenient for installation and disassembly during use.

The above descriptions are merely specific embodiments of the present disclosure, but the protection scope of the present disclosure is not limited thereto. Any changes or replacements within the technical scope disclosed by the present disclosure shall fall within the protection scope of the present disclosure.

What is claimed is:

1. A grill pan assembly, for placement above a charcoal or gas stove to grill food by heat conduction, comprising:
a bracket and a grill pan, the grill pan being detachably disposed on the bracket;
wherein the grill pan comprises a first surface and a second surface that are oppositely disposed along a thickness direction, both the first surface and the second surface being configured to grill food; and wherein the first surface is provided with a plurality of protrusions protruding from the first surface in a direction away from the second surface;
wherein the grill pan assembly has a first state and a second state; And wherein, when the grill pan assembly is in the first state, the grill pan is placed on the bracket with the first surface facing upward; and when the grill pan assembly is in the second state, the grill pan is placed on the bracket with the second surface facing upward.

2. The grill pan assembly according to claim 1, wherein the grill pan further comprises a first surrounding wall and a first oil storage groove located on the same side as the first surface, the first surrounding wall surrounding the first surface, the first oil storage groove being disposed between the first surface and the first surrounding wall and recessed in a direction toward the second surface;
wherein the grill pan further comprises a second surrounding wall and a second oil storage groove located on the same side as the second surface, the second surrounding wall surrounding the second surface, the second oil storage groove being disposed between the second surface and the second surrounding wall and recessed in a direction toward the first surface.

3. The grill pan assembly according to claim 2, wherein the plurality of protrusions is strip-shaped and extends along direction parallel to a width direction or a length direction of the grill pan, the plurality of protrusions being spaced apart from one another, and wherein multiple grooves are formed between every two adjacent protrusions and are in communication with the first oil storage groove; and
wherein, when the grill pan assembly is placed on a horizontal plane with the first surface facing upward, liquid on the first surface flows along the multiple grooves toward the first oil storage groove.

4. The grill pan assembly according to claim 2, wherein when the grill pan assembly is placed on a horizontal plane with the first surface facing upward, the first surface is inclined relative to the horizontal plane such that a region of the first surface near the first oil storage groove is lower than a region of the first surface away from the first oil storage groove; and
wherein, when the grill pan assembly is placed on a horizontal plane with the second surface facing upward, the second surface is inclined relative to the horizontal plane such that a region of the second surface near the second oil storage groove is lower than a region of the second surface away from the second oil storage groove.

5. The grill pan assembly according to claim 2, wherein the grill pan further comprises at one or both of a first conduit and a second conduit;
wherein one end of the first conduit is disposed at a bottom of the first oil storage groove and the other end of the first conduit is disposed on a side wall of the grill pan or on the second surface, the first conduit being configured to drain liquid inside the first oil storage groove outward; and
wherein one end of the second conduit is disposed at a bottom of the second oil storage groove and the other end of the second conduit is disposed on the side wall of the grill pan or on one side of the first surface, the second conduit being configured to drain liquid inside the second oil storage groove outward.

6. The grill pan assembly according to claim 1, wherein the grill pan assembly further comprises an adjusting component, one end of the adjusting component being rotatably connected to the bracket and the other end of the adjusting component being movably supported on the grill pan; and
wherein, by rotating the adjusting component to change a position at which the adjusting component is connected to the grill pan, an angle at which the grill pan is placed on the bracket becomes adjustable.

7. The grill pan assembly according to claim 1, wherein the bracket comprises a support platform and a through hole extending vertically through the support platform, the grill pan is placed on the support platform, and the through hole is located below the grill pan.

8. The grill pan assembly according to claim 7, wherein the grill pan assembly comprises two grill pans disposed side by side transversely on the support platform;
wherein, when the grill pan assembly is placed on a horizontal plane, the first surfaces of the two grill pans both face upward, or the second surfaces of the two grill pans both face upward, or the first surface of one of the two grill pans faces upward while the second surface of the other grill pan faces upward.

9. The grill pan assembly according to claim 8, wherein each of the two grill pans further comprises at least two insertion holes;
wherein the grill pan assembly further comprises a fixing frame, two ends of the fixing frame are movably inserted into the at least two insertion holes;
wherein the fixing frame has a third state and a fourth state relative to the two grill pans; and wherein, when the fixing frame is in the third state, the two ends of the fixing frame are inserted into two insertion holes of one of the two grill pans, and when the fixing frame is in the fourth state, one end of the fixing frame is inserted into one insertion hole of one of the two grill pans and the other end of the fixing frame is inserted into one insertion hole of the other one of the two grill pans, a connecting line connecting the two ends of the fixing frame being parallel to an arrangement direction of the two grill pans.

10. The grill pan assembly according to claim 7, wherein the grill pan is movably placed on the support platform and slides along a length direction of the bracket to adjust a position of the grill pan.

11. The grill pan assembly according to claim 9, wherein the fixing frame comprises a first end, an intermediate end and a second end that are fixedly connected in sequence, the first end and the second end each form a 90° angle with the intermediate end; and
wherein distal ends of the first end and the second end are provided with temperature sensors, each of the temperature sensors being inserted into one of the at least two insertion holes;
wherein the fixing frame further comprises a signal transmission module electrically connected to the temperature sensors, the signal transmission module is configured to wirelessly transmit temperature signals detected by the temperature sensors to a mobile terminal.

12. The grill pan assembly according to claim 11, wherein the first end and the second end are made of a heat-conductive material, and the intermediate end is made of a heat-insulating material.

13. The grill pan assembly according to claim 11, wherein when the fixing frame is connected to the two grill pans, the temperature sensors on the first end and the second end are respectively configured to detect temperatures of the two grill pans.

14. The grill pan assembly according to claim 11, wherein the signal transmission module is a Bluetooth module.

15. The grill pan assembly according to claim 11, wherein the at least two insertion holes are provided with two snap-fit holes, and the fixing frame is provided with two snap-fit components configured to cooperate with the two snap-fit holes;
wherein, when the two snap-fit components are in a snap-fit state, the two snap-fit components are embedded into the two snap-fit holes so as to relatively fix the fixing frame to the grill pan; and
when the two snap-fit components are in a snap-fit released state, the two snap-fit components are disengaged from the two snap-fit holes so that the fixing frame to be pulled out relative to the respective grill pan.

16. The grill pan assembly according to claim 15, wherein the fixing frame is internally provided with a mounting channel, the first end is provided with a first snap-fit groove, the second end is provided with a second snap-fit groove; and
each snap-fit component comprises:
a first snap-fit block slidably connected to the first snap-fit groove;
a first spring located between the first snap-fit block and a bottom of the first snap-fit groove and configured to urge the first snap-fit block to embed into the corresponding snap-fit hole;
a first pull cord, one end of the first pull cord being fixedly connected to the first snap-fit block and the other end of the first pull cord being located in the mounting channel;
a second snap-fit block slidably connected to the second snap-fit groove;
a second spring located between the second snap-fit block and a bottom of the second snap-fit groove and configured to urge the second snap-fit block to embed into the corresponding snap-fit hole;
a second pull cord, one end of the second pull cord being fixedly connected to the second snap-fit block and the other end of the second pull cord being located in the mounting channel;
a rotating shaft, one end of the rotating shaft being located inside the mounting channel and the other end of the rotating shaft extending out of the intermediate end, the other ends of the first pull cord and the second pull cord both being wound around the one end of the rotating shaft;
wherein, when the rotating shaft is rotated, the first pull cord drives the first snap-fit block to move in a direction away from the corresponding snap-fit hole, so that the first snap-fit block disengages from the corresponding snap-fit hole; and the second pull cord drives the second snap-fit block to move in a direction away from the corresponding snap-fit hole, so that the second snap-fit block disengages from the corresponding snap-fit hole;
wherein, after both the first snap-fit block and the second snap-fit block disengage from the corresponding snap-fit holes, the fixing frame is configured to be pulled out from the corresponding insertion holes; and
wherein, when an external force applied to the rotating shaft is removed, the first spring urges the first snap-fit block to move toward the corresponding snap-fit hole and embed into the corresponding snap-fit hole, and the second spring urges the second snap-fit block to move toward the corresponding snap-fit hole and embed into the corresponding snap-fit hole.

17. The grill pan assembly according to claim 16, wherein an end of the rotating shaft extending out of the intermediate end is provided with a control component.
